(19) United States
(12) Patent Application Publication
(10) Pub. No.: US 2024/0289895 A1
(43) Pub. Date: Aug. 29, 2024

(54) SYSTEMS AND METHODS FOR USER MATCHMAKING AND SOCIAL NETWORKING BASED ON SHARED INTERESTS

(71) Applicant: Joshua Baker, Mitchellville, MD (US)

(72) Inventor: Joshua Baker, Mitchellville, MD (US)

(21) Appl. No.: 18/114,746

(22) Filed: Feb. 27, 2023

(51) Int. Cl. G06Q 50/00

(52) U.S. Cl. CPC G06Q 50/01

(57) ABSTRACT

The present disclosure relates to a method or computer program product that facilitates connection of users' smart devices where users share common interests, and in particular, common interest in events. The system may generate event listings on smart devices that users are interested in, allow users to see all other users that are interested in the common event, allow users to send a like to users in the common event space who they want to establish communication with, and then match user devices with other user devices who have accepted the like and facilitated a match with each other. The system may narrow the scope of users having shared interest by region, cost, event type, and event hosts.

### TECHNICAL FIELD

The embodiments generally relate to the field of mobile device-to-device connection via software applications.

### BACKGROUND

Existing dating or social networking applications allow for profile customization and filters to find an individual to match with but fail to ensure users will take their interactions to the next level and meet in person and develop a personal relationship.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The present disclosure relates to an application for connecting mobile devices, such as smart devices including smartphones.

The present disclosure relates to a method or computer program that enables users to connect with and find others with common interests, and in particular, common interest in events. The system may be configured to establish wireless communication via smart devices between users having shared interests. The system may allow users to find an event in their local area that they are interested in and then match with other users also interested in the same event. The system may narrow the scope of users having shared interest by region, cost, event type, and event hosts.

Both the foregoing general description and the following detailed description present embodiments intended to provide an overview or framework for understanding the nature and character of the embodiments disclosed herein. Any accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of a computing system, according to some embodiments described herein;

FIG. 2 illustrates a block diagram of a computing system, according to some embodiments described herein;

FIG. 3 illustrates a block diagram of a software application and associated

modules, according to some embodiments described herein;

FIG. 4 illustrates a flowchart of a use case of a software application according to some embodiments described herein; and

FIG. 5 illustrates a flowchart of a use case of a software application according to some embodiments described herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system or methods of use. Any specific details of the embodiments are used for demonstration purposes only and no unnecessary limitations or inferences are to be understood from there.

The present disclosure relates to a method or computer program that enables users to connect and find others with common interests, and in particular, common interest in events. The system may allow users to find an event in their local area that they are interested in and then match with other users also interested in the same event. The system may narrow the scope of users having shared interest by region, cost, event type, and event hosts.

Users may be allowed to search, filter, and select events of their interest as well as generate events of their own within the sense system. Once a user finds an event that they may be interested in they will be able to view the profiles of other users who have shared interest in that particular event. Users having shared interests in particular events will be tagged by the system and the system may automate communication between devices of users having shared interests. Users having shared interest may be able to communicate with one another via the system, such as video Wi-Fi connection or cellular data connection.

The system may be configured to allow moderator or administrator users to establish events and to generate rule sets and behavioral rules with respect to how users may interact with particular events. administrator users may utilize the system to generate filter rolls, tags, or flags associated with their particular events.

The present disclosure relates to a method for dataset correlation based on event interest, including establishing, via a computer, a first set of user preferences including at least one of preferred event types, preferred regions, or preferred event costs based on user profile data. The method may display, via a display on a user device, the at least one of preferred event types, preferred regions, or preferred event costs; receiving user input to identify at least one of the displayed preferred event types, preferred regions, or preferred event costs. The system may select, via the processor set, a plurality of user profiles based on the first set of user preferences. The system may generate a commonality dataset including the first set of user preferences and a plurality of user profiles having shared preferred event types, preferred regions, or preferred event costs into a shared interest group set. The system may further establish, via the processor set and a wireless connection, communication between one or more devices associated with the user profiles in the commonality dataset. In this way, users may benefit from the system by the automated grouping and displaying of users having shared interests and facilitating communication of devices owned by said users.

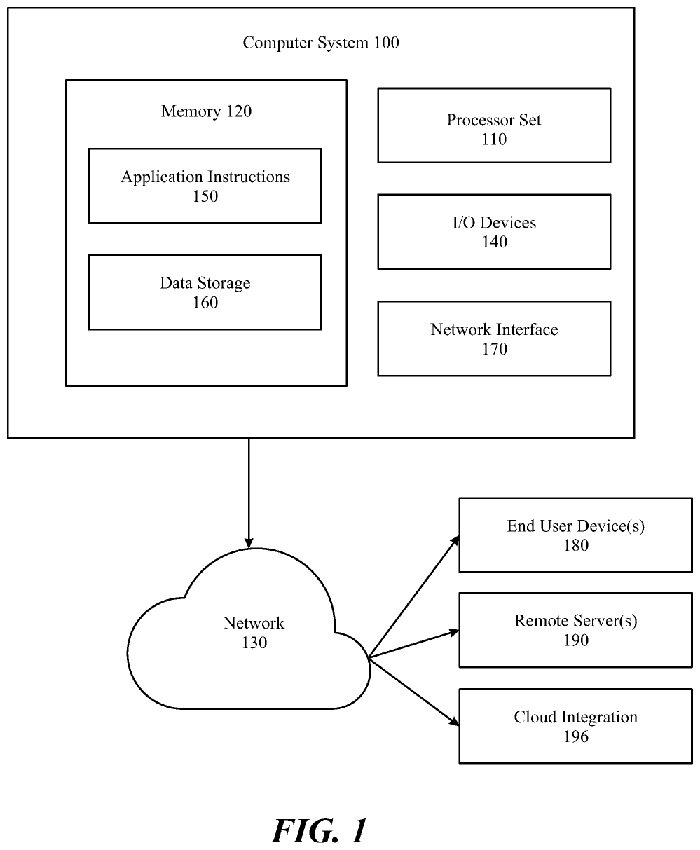

Referring to FIG. 1, a computer system 100 may include memory 120, a processor 110, input/output devices 140, and a network interface 170 constructed and arranged to facilitate communication with a network 130. The memory 120 may include computer-readable application instructions 150, configured to implement certain embodiments described herein, and a database 160, comprising various data accessible by the application instructions 150. In some embodiments, the steps and actions of the application instructions 150 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 150 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 150 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, to perform aspects of the present disclosure.

In some embodiments, the application instructions 150 can be downloaded to a computing/processing device from a computer readable storage medium, or to an external computer or external storage device via a network 130. A network adapter card or network interface in each computing/processing device receives computer readable program instructions from the network and forwards the computer readable application instructions 150 for storage in a computer readable storage medium within the respective computing or processing device.

In some embodiments, the computer system 100 includes a network interface 170 to communicate with a network 130. In some embodiments, the network interface 170 is configured to allow data to be exchanged between the computer system 100 and other devices attached to the network 130, such as other computer systems, or between nodes of the computer system 100. In various embodiments, the network interface 170 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network or protocol.

In some embodiments, the network 130 corresponds to a local area network (LAN), wide area network (WAN), the Internet, a direct peer-to-peer network (e.g., device to device Wi-Fi, Bluetooth, etc.), or an indirect peer-to-peer network (e.g., devices communicating through a server, router, or other network device). The network 130 can comprise copper transmission cables, optical transmission fibers, wireless transmission, routers, firewalls, switches, gateway computers or edge servers. The network 130 can represent a single network or multiple networks. In some embodiments, the network 130 used by the various devices of system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The network 130 may be configured to facilitate operable communication between the computer system 100 and any of end user devices 180, remote servers 190 or remote computer systems, or cloud network integrations 196.

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

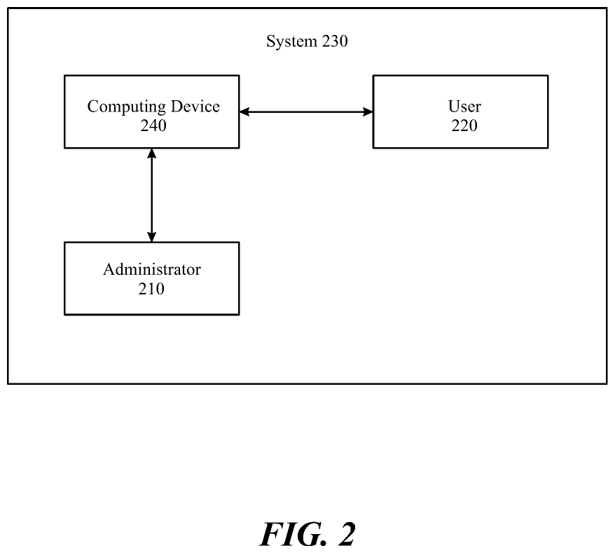

In reference to FIG. 2, an exemplary network infrastructure is illustrated having an administrator 210 who can create, delete, activate, or deactivate users of the system, in addition to performing other administrative tasks. A user 220 operates the computing device 240 to generate, edit, receive, or otherwise interact with other users sharing common interests. The system 230 utilizes at least one computing devices 240 to permit a user interface to allow a user to access the system 230.

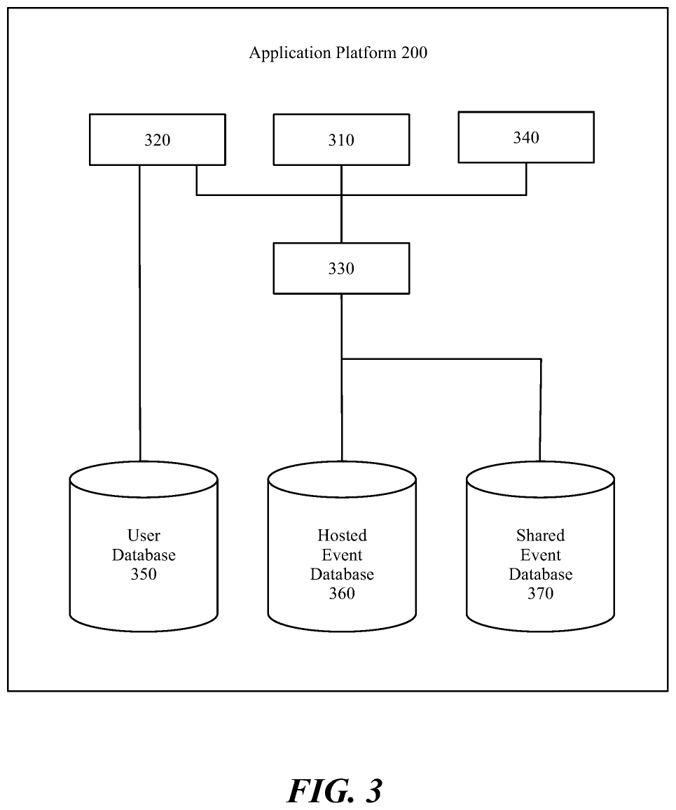

In reference to FIG. 3, the application platform 300 and databases are illustrated. A number of databases accessible by the platform 300 may include a user database 350, a hosted event database 360, and a shared event database 370. A login module 310 may authorize users to log in to the application and performs processes for password recovery, or other login credential changes. The login module 310 may include captcha functionality to determine whether the user is human or a computer. The login module 310 or user access module may include additional security measures such as electronic authentication, including multi-factor authentication or two factor authentications. Additional security features and security measures may be implemented throughout the system as will be described herein.

The user management module 320 may be utilized by an administrator to invite and manage users as well as creating roles for each new or existing user. The user management module 320 may allow the creation, deletion, activation, or deactivation of other users and may receive user information, where the user is an individual user, event hosting user, or user sharing event data.

A user registration module 340 is provided to intake and process user registration information. A user may not be able to login to the application until an administrator verifies the user account. The user registration module 340 may be utilized by the administrator to invite users as well as creating roles for each new or existing user. Roles may be defined as administrative or user. The user registration module 340 may require the administrator to verify details prior to allowing the user access to the system.

Where the user is a customer user, the user registration module 340 may receive provider information such as last name, middle name or initial, first name, suffix, phone number, email address, mobile number, address, or other relevant contact information. The user registration module 340 may also receive information regarding payment methods such as credit card details, banking information, or the like.

A user permissions and access module 330 provides the functionality to the administrator to provide access for the users to one or more of the plurality of modules described herein. The user permissions and access module 330 may also allow the administrator to view, modify, and administer user permission settings within the applications. The user permissions and access module 330 may also allow users to access the hosted event database 360 and shared event database 370, which may store data relating to hosted events and shared events, respectively.

The user permissions and access module 330 may allow users to view, search, sort, filter, tag, group, and share any of the hosted events and shared events to their respective user profile, or to a shared event feed depicted via a graphical user interface (GUI) on various user devices.

The user permissions and access module 330 may allow users to specify types of users or events they desire to interact with, or to sort or view users and events based on a target demographic or geographical region. Users may be allowed to select events and view users with shared interest in the target event.

The user permissions and access module 330 may facilitate inter-user communication via messaging functionality.

The user database 350, hosted event database 360, and shared event database 370 may include any tangible device that can receive and store instructions or datasets for use by a computer processor as required by the application instructions. User database 350 may store data such as, but not limited to, user profile data and target relationship data, friend-user data, desired event data, and the like. The hosted event database 360 may store data related to event data submitted to the system by host users. Host users may include individual, companies, or entities hosting events that desire to have their event seen or found via the system by users. The shared event database 370 may include hosted events which are compiled in the shared event database 370 when shared publicly in an event feed or when shared by one user to another.

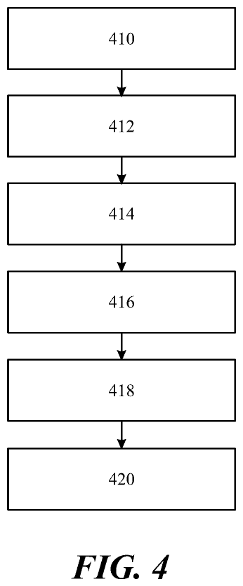

In reference to FIG. 4, a flowchart of a use case diagram 400 includes a customer user utilizing the system to create a personal profile in step 410. A user may set preferences in step 412, such as, but not limited to, preferred event types, preferred regions, preferred event costs, and the like. Similarly, a user may identify or filter undesirable event types, regions, costs, and the like.

In step 414, a user may search, filter, or otherwise find a desired or appealing event either listed by an event sponsor or owner or as shared by another user. Events may be stored, searched, and shared via the hosted event database 360 and shared event database 370 as depicted in FIG. 3.

A user may also proclaim interest, in step 416, in an event. Proclaiming interest may be accomplished via a selectable icon within a GUI or other similar means. Proclaiming interest will allow a first user's access to the profiles of all other users who have proclaimed interest in the same event. Multiple users may proclaim interest in an event in step 416. In step 418, users can send a “like” to other users who have also proclaimed interest in the event. Sending a “like” may include receiving user input to confirm the desire to establish communication between one or more devices associated with the user profiles in the commonality dataset. Users who receive likes have the option to accept a like, via a GUI on a smart device. If a like is accepted, in step 420, the system matches the users into a commonality dataset. Further in step 420, once there is a match the system will systematically group matched users and facilitate communication between the devices of users in the shared interest group such that a plurality of users may interact with one another via smart device prior to, during, and after specified events.

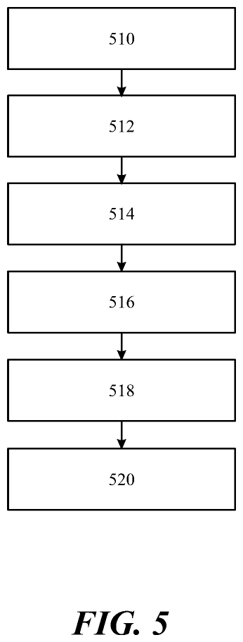

Referring to FIG. 5, a flowchart of a use case diagram includes multiple customer users utilizing the system to identify shared interest in preferred event types, preferred regions, or preferred event cost. According to step 510, the system may establish, via a processor set, a set of user preferences including at least one of preferred event types, preferred regions, or preferred event costs based on user profile data. According to step 512, the system may establish, via the processor set, a set of user non-preferred event types, non-preferred regions, or non-preferred event costs based on user profile data. According to step 514, the system may display, via a display on a user device, the at least one of preferred event types, preferred regions, or preferred event costs. According to step 516, the system may receive user input to identify at least one of the displayed preferred event types, preferred regions, or preferred event costs. According to step 518, the system may select, via the processor set, a plurality of user profiles based on the preferred event types, preferred regions, or preferred event costs and form a commonality dataset of users having shared preferred event types, preferred regions, or preferred event costs into a shared interest group set. According to step 520, the system may establish, via the processor set and a wireless connection, confirm with at least one user that they desire to establish communication between one or more devices of users in the commonality dataset. Communication between one or more devices of users in the commonality dataset may be established after at least one user has accepted a like sent from another user.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a method for dataset correlation based on event interest, may include establishing, via a processor set, a first set of user preferences including at least one of preferred event types, preferred regions, or preferred event costs based on user profile data; displaying, via a display on a user device, the at least one of preferred event types, preferred regions, or preferred event costs; receiving user input to identify at least one of the displayed preferred event types, preferred regions, or preferred event costs; selecting, via the processor set, a plurality of user profiles based on the first set of user preferences; generating a commonality dataset including the first set of user preferences and a plurality of user profiles having shared preferred event types, preferred regions, or preferred event costs into a shared interest group set; receiving, via a graphical user interface, user input to confirm communication between one or more devices associated with the user profiles in the commonality dataset; and establishing, via the processor set and a wireless connection, communication between one or more devices associated with the user profiles in the commonality dataset.

Variation 2 may include a method for dataset correlation based on event interest as in variation 1, wherein the commonality dataset includes shared preferred event types of multiple users.

Variation 3 may include a method for dataset correlation based on event interest as in variations 1 or 2, wherein the commonality dataset includes shared preferred regions of multiple users.

Variation 4 may include a method for dataset correlation based on event interest as in any of variations 1 through 3, wherein the commonality dataset includes shared preferred event costs of multiple users.

Variation 5 may include a method for dataset correlation based on event interest as in any of variations 1 through 4, further including establishing, via the processor set, a set of user non-preferred event types, non-preferred regions, or non-preferred event costs based on user profile data; and preventing the display of the set of user non-preferred event types, non-preferred regions, or non-preferred event costs based on user profile data on a user device.

Variation 6 may include a method for dataset correlation based on event interest as in any of variations 1 through 5, further including communicating the first set of user preferences to the one or more devices associated with the user profiles in the commonality dataset

Variation 7 may include a method for dataset correlation based on event interest as in any of variations 1 through 6, wherein communication between one or more devices associated with the user profiles in the commonality dataset includes communication via at least one of cellular or Wi-Fi.

Variation 8 may include a method for dataset correlation based on event interest as in any of variations 1 through 7, wherein communication between one or more devices associated with the user profiles in the commonality dataset includes communication via messaging, voice, or video.

Variation 9 may include a method for dataset correlation based on event interest as in any of variations 1 through 8, further including displaying, via a display on a user device, the commonality dataset including the first set of user preferences and a plurality of user profiles having shared preferred event types, preferred regions, or preferred event costs into a shared interest group set.

Variation 10 may include a method for dataset correlation based on event interest as in any of variations 1 through 9, further including modifying the first set of user preferences based on user input.

According to variation 11, a computer program product may include at least one computer readable storage media including program instructions, the program instructions configured to establish a set of user preferences including at least one of preferred event types, preferred regions, or preferred event costs based on user profile data; establish a set of user non-preferred event types, non-preferred regions, or non-preferred event costs based on user profile data; display the at least one of preferred event types, preferred regions, or preferred event costs on a user device; receive user input to identify at least one of the displayed preferred event types, preferred regions, or preferred event costs; select a plurality of user profiles based on the preferred event types, preferred regions, or preferred event costs; generate a commonality dataset of users having shared preferred event types, preferred regions, or preferred event costs into a shared interest group set; receiving, via a graphical user interface, user input to confirm communication between one or more devices associated with the user profiles in the commonality dataset; and establish communication between one or more devices of users in the commonality dataset.

Variation 12 may include a computer program product including at least one computer readable storage media including program instructions as in variation 11, wherein the commonality dataset includes shared preferred event types of multiple users.

Variation 13 may include a computer program product including at least one computer readable storage media including program instructions as in variation 11 or 12, wherein the commonality dataset includes shared preferred regions of multiple users.

Variation 14 may include a computer program product including at least one computer readable storage media including program instructions as in any of variations 11 through 13, wherein the commonality dataset includes shared preferred event costs of multiple users.

Variation 15 may include a computer program product including at least one computer readable storage media including program instructions as in any of variations 11 through 14, further including establishing a set of user non-preferred event types, non-preferred regions, or non-preferred event costs based on user profile data; and preventing the display of the set of user non-preferred event types, non-preferred regions, or non-preferred event costs based on user profile data on a user device.

Variation 16 may include a computer program product including at least one computer readable storage media including program instructions as in any of variations 11 through 15, further including communicating the set of user preferences to the one or more devices associated with the user profiles in the commonality dataset.

Variation 17 may include a computer program product including at least one computer readable storage media including program instructions as in any of variations 11 through 16, wherein communication between one or more devices associated with the user profiles in the commonality dataset includes communication via at least one of cellular or Wi-Fi.

Variation 18 may include a computer program product including at least one computer readable storage media including program instructions as in any of variations 11 through 17, wherein communication between one or more devices associated with the user profiles in the commonality dataset includes communication via messaging, voice, or video.

Variation 19 may include a computer program product including at least one computer readable storage media including program instructions as in any of variations 11 through 18, further including displaying, via a display on a user device, the commonality dataset including the first set of user preferences and a plurality of user profiles having shared preferred event types, preferred regions, or preferred event costs into a shared interest group set.

According to variation 20, a method for dataset correlation based on event interest, may include establishing, via a processor set, a first set of user preferences including at least one of preferred event types, preferred regions, or preferred event costs based on user profile data; establishing, via the processor set, a set of user non-preferred event types, non-preferred regions, or non-preferred event costs based on user profile data; displaying, via a display on a user device, at least one of preferred event types, preferred regions, or preferred event costs; executing a rule set preventing the display of the set of user non-preferred event types, non-preferred regions, or non-preferred event costs based on user profile data on a user device; receiving user input to identify at least one of the displayed preferred event types, preferred regions, or preferred event costs; selecting, via the processor set, a plurality of user profiles based on the first set of user preferences; generating a commonality dataset including the first set of user preferences and a plurality of user profiles having shared preferred event types, preferred regions, or preferred event costs into a shared interest group set; establishing, via the processor set and a wireless connection, communication between one or more devices associated with the user profiles in the commonality dataset when approved by a user; communicating, via at least one of cellular or Wi-Fi communication, the first set of user preferences to one or more devices associated with the user profiles in the commonality dataset; receiving, via a graphical user interface, user input to confirm communication between one or more devices associated with the user profiles in the commonality dataset; and displaying, via a display on a user device, the commonality dataset including the first set of user preferences and a plurality of user profiles having shared preferred event types, preferred regions, or preferred event costs into a shared interest group set.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/we claim:

1. A method for dataset correlation based on event interest, comprising:
establishing, via a processor set, a first set of user preferences including at least one of preferred event types, preferred regions, or preferred event costs based on user profile data;
displaying, via a display on a user device, the at least one of preferred event types, preferred regions, or preferred event costs;
receiving user input to identify at least one of the displayed preferred event types, preferred regions, or preferred event costs;
selecting, via the processor set, a plurality of user profiles based on the first set of user preferences;
generating a commonality dataset comprising the first set of user preferences and a plurality of user profiles having shared preferred event types, preferred regions, or preferred event costs into a shared interest group set;
receiving, via a graphical user interface, user input to confirm communication between one or more devices associated with the user profiles in the commonality dataset; and
establishing, via the processor set and a wireless connection, communication between one or more devices associated with the user profiles in the commonality dataset.

2. The method for dataset correlation based on event interest as in claim 1, wherein the commonality dataset comprises shared preferred event types of multiple users.

3. The method for dataset correlation based on event interest as in claim 1, wherein the commonality dataset comprises shared preferred regions of multiple users.

4. The method for dataset correlation based on event interest as in claim 1, wherein the commonality dataset comprises shared preferred event costs of multiple users.

5. The method for dataset correlation based on event interest as in claim 1, further comprising:
establishing, via the processor set, a set of user non-preferred event types, non-preferred regions, or non-preferred event costs based on user profile data; and
preventing the display of the set of user non-preferred event types, non-preferred regions, or non-preferred event costs based on user profile data on a user device.

6. The method for dataset correlation based on event interest as in claim 1, further comprising communicating the first set of user preferences to the one or more devices associated with the user profiles in the commonality dataset.

7. The method for dataset correlation based on event interest as in claim 1, wherein communication between one or more devices associated with the user profiles in the commonality dataset comprises communication via at least one of cellular or Wi-Fi after a match is established.

8. The method for dataset correlation based on event interest as in claim 1, wherein communication between one or more devices associated with the user profiles in the commonality dataset comprises communication via messaging, voice, or video after a match is established.

9. The method for dataset correlation based on event interest as in claim 1, further comprising displaying, via a display on a user device, the commonality dataset comprising the first set of user preferences and a plurality of user profiles having shared preferred event types, preferred regions, or preferred event costs into a shared interest group set.

10. The method for dataset correlation based on event interest as in claim 1, further comprising modifying the first set of user preferences based on user input.

11. A computer program product comprising at least one computer readable storage media comprising program instructions, the program instructions configured to:
establish a set of user preferences including at least one of preferred event types, preferred regions, or preferred event costs based on user profile data;
establish a set of user non-preferred event types, non-preferred regions, or non-preferred event costs based on user profile data;
display the at least one of preferred event types, preferred regions, or preferred event costs on a user device;
receive user input to identify at least one of the displayed preferred event types, preferred regions, or preferred event costs;
select a plurality of user profiles based on the preferred event types, preferred regions, or preferred event costs;
generate a commonality dataset of users having shared preferred event types, preferred regions, or preferred event costs into a shared interest group set;
receiving, via a graphical user interface, user input to confirm communication between one or more devices associated with the user profiles in the commonality dataset; and
establish communication between one or more devices of users in the commonality dataset.

12. A computer program product comprising at least one computer readable storage media comprising program instructions as in claim 11, wherein the commonality dataset comprises shared preferred event types of multiple users.

13. The computer program product comprising at least one computer readable storage media comprising program instructions as in claim 11, wherein the commonality dataset comprises shared preferred regions of multiple users.

14. The computer program product comprising at least one computer readable storage media comprising program instructions as in claim 11, wherein the commonality dataset comprises shared preferred event costs of multiple users.

15. The computer program product comprising at least one computer readable storage media comprising program instructions as in claim 11, further comprising:
establishing a set of user non-preferred event types, non-preferred regions, or non-preferred event costs based on user profile data; and
preventing the display of the set of user non-preferred event types, non-preferred regions, or non-preferred event costs based on user profile data on a user device.

16. The computer program product comprising at least one computer readable storage media comprising program instructions as in claim 11, further comprising communicating the set of user preferences to the one or more devices associated with the user profiles in the commonality dataset.

17. The computer program product comprising at least one computer readable storage media comprising program instructions as in claim 11, wherein communication between one or more devices associated with the user profiles in the commonality dataset comprises communication via at least one of cellular or Wi-Fi after user confirmation.

18. The computer program product comprising at least one computer readable storage media comprising program instructions as in claim 11, wherein communication between one or more devices associated with the user profiles in the commonality dataset comprises communication via messaging, voice, or video after user confirmation.

19. The computer program product comprising at least one computer readable storage media comprising program instructions as in claim 11, further comprising displaying, via a display on a user device, the commonality dataset comprising the first set of user preferences and a plurality of user profiles having shared preferred event types, preferred regions, or preferred event costs into a shared interest group set.

20. A method for dataset correlation based on event interest, comprising:
establishing, via a processor set, a first set of user preferences including at least one of preferred event types, preferred regions, or preferred event costs based on user profile data;
establishing, via the processor set, a set of user non-preferred event types, non-preferred regions, or non-preferred event costs based on user profile data;
displaying, via a display on a user device, the at least one of preferred event types, preferred regions, or preferred event costs;
executing a rule set preventing the display of the set of user non-preferred event types, non-preferred regions, or non-preferred event costs based on user profile data on a user device;
receiving user input to identify at least one of the displayed preferred event types, preferred regions, or preferred event costs;
selecting, via the processor set, a plurality of user profiles based on the first set of user preferences;
generating a commonality dataset comprising the first set of user preferences and a plurality of user profiles having shared preferred event types, preferred regions, or preferred event costs into a shared interest group set;
receiving, via a graphical user interface, user input to confirm communication between one or more devices associated with the user profiles in the commonality dataset; and
establishing, via the processor set and a wireless connection, communication between one or more devices associated with the user profiles in the commonality dataset after a match is established;
communicating, via at least one of cellular or Wi-Fi communication, the first set of user preferences to the one or more devices associated with the user profiles in the commonality dataset; and
displaying, via a display on a user device, the commonality dataset comprising the first set of user preferences and a plurality of user profiles having shared preferred event types, preferred regions, or preferred event costs into a shared interest group set.
